(19) United States
(12) Patent Application Publication
(10) Pub. No.: US 2005/0044549 A1
(43) Pub. Date: Feb. 24, 2005

(54) Data processing apparatus

(75) Inventors: Takeshi Morikawa, Takarazuka-shi (JP); Masaya Hashimoto, Amagasaki-shi (JP); Nobuo Kamei, Amagasaki-shi (JP); Daisuke Sakiyama, Maizuru-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc., Chiyoda-ku (JP)

(21) Appl. No.: 10/772,443

(22) Filed: Feb. 6, 2004

(30) Foreign Application Priority Data
Aug. 18, 2003 (JP) 2003-294572

(51) Int. Cl. G06F 9/46

(52) U.S. Cl. 718/102

(57) ABSTRACT

When a request for compression or decompression of data for a next job is issued while processing of an current job is underway by one or more compression/decompression unit[s], the minimum processing time for the next-job data is compared with the processing wait period between pages of the current job. It is determined based on the results of this comparison whether or not compression or decompression of the next-job data is to be permitted. Based on this determination, control is carried out regarding whether or not compression or decompression of the next job by the compression/decompression unit[s] between pages of the current job is to be executed.

The present application claims priority to Japanese Patent Application No. 2003-294572 filed Aug. 18, 2003, the entire content of which is hereby incorporated by reference.

### BACKGROUND OF THE INVENTION

1. Field of the Invention

The present invention relates to a data processing apparatus used in a multi-function peripheral (MFP) or the like, which constitutes an apparatus having multiple functions such as a copier function, a printer function, a scanner function and a facsimile function.

2. Description of the Related Art

In order to perform these multiple functions, the MFP described above includes multiple input means, such as, for example, a receiving unit that receives print jobs sent over a network from an external terminal device such as a personal computer, a receiving unit that receives facsimile (hereinafter ‘fax’) jobs sent over a communication network from an external device such as a fax machine, and an original document reader that reads original documents.

Furthermore, the MFP includes a printer unit or the like that prints image data read by the original document reader and print data sent from an external terminal device. It also includes a file memory that stores data input from the various input means.

In order to reduce the amount of memory required to store the data that is stored in this file memory, a compression/decompression unit that compresses and decompresses the data is generally incorporated in the MFP. The input data is sent to the compression/decompression unit and compressed, and this compressed data is stored in the file memory.

In this type of MFP, an instruction may be issued requesting that the image data for an original document read by the original document reader be compressed or decompressed while a print job sent from an external device is being compressed or decompressed by the compression/decompression unit.

In such a situation, in the conventional art, the compression/decompression unit alternates processing between the job currently being processed and the job for which the processing request was issued.

However, this alternating processing method entails the flaw that, where the processing for the new job takes a substantial amount of time, the processing of the current job is delayed, thereby reducing printing productivity

Furthermore, in order to prevent this problem, it is possible to incorporate multiple compression/decompression units and use one or more as compression units and one or more of the others as decompression units in a dedicated manner in the initial construction, but because each compression/decompression unit can carry out only one type of operation even where only one job is waiting for processing, such a solution entails reduced processing capacity.

Accordingly, a technology has been disclosed wherein where a processing request on a band unit or block unit basis is issued for a second job while data for a first job is being compressed or decompressed by the compression/decompression unit, the data for the second job is processed between pages of the job currently being processed (Japanese Laid-Open Patent Application 2002-278729). In addition, a technology has been disclosed in which a copy job is inserted via interrupt between pages of the current job in accordance with the amount of print job remaining for processing (Japanese Laid-Open Patent Application 2002-234233).

However, using the technology of Japanese Laid-Open Patent Application 2002-278729 described above, it is difficult to handle the situation in which various different types of jobs are input, as in the case of an MFP, such as where processing is required not only for data that is compressed or decompressed on a block unit basis, but also for page unit data.

In addition, because the technology described in Japanese Laid-Open Patent Application 2002-234233 uses interrupt processing, it entails the problem of reduced print job productivity during processing of the current job.

### SUMMARY OF THE INVENTION

A main object of the present invention is to provide a data processing apparatus that, where a processing request for a second job is received while data for an existing job (hereinafter the ‘current job’) is being compressed or decompressed, can increase overall processing efficiency without a reduction in productivity with regard to the current job.

In order to achieve this and other objects, according to one aspect of the present invention, the data processing apparatus includes the following:
one or more compression/decompression units that compress the data for the input job and decompress the compressed data; and
a controller that, when a request is issued for processing of the data for a next job by the compression/decompression unit(s) during processing of the data for the current job by the compression/decompression unit(s), obtains the processing wait period between pages of the current job, determines whether or not the data for the next job will undergo compression or decompression based on a comparison between the minimum processing time for the next-job data and the processing wait period, and controls the execution of processing of the next job by the compression/decompression unit(s) between pages of the current job in accordance with this determination.

According to this data processing apparatus, if the processing wait period between pages of the current job is longer than the minimum processing time for the next-job data, at least minimal processing of the next-job data can be performed during the processing wait period for the current job, and therefore next-job processing is carried out between pages of the current job. Conversely, if the processing wait period between pages of the current job is shorter than the minimum processing time for the next-job data, processing of the current job would be delayed by the execution of processing of the next-job data during the processing wait period for the current job, and therefore next-job processing is put on hold.

Because next-job processing is conducted only so long as there is no effect on current job processing as described above, there is no reduction in productivity due to a delay in current-job processing. Furthermore, because the determination as to whether the next-job data will be compressed or decompressed is made based on the result of comparison between the minimum processing time for the next-job data and the processing wait period between pages of the current job, as obtained by processing wait period obtaining means, appropriate processing control is executed irrespective of the type of the next job, and overall processing efficiency for the apparatus is improved.

According to another aspect of the present invention, the data processing apparatus includes the following:
one or more compression/decompression unit(s) that compress the data for the input job and decompress the compressed data; and
a controller that, when a request is issued for processing of the data for a next job by the compression/decompression unit(s) during processing of the data for the current job by the compression/decompression unit(s), identifies an attribute of the next job, determines whether or not the data for the next job will undergo compression or decompression based on the identified next-job attribute, and controls the execution of processing of the next job by the compression/decompression unit(s) between pages of the current job in accordance with this determination.

According to this data processing apparatus, when a request is issued for processing of the data for a next job by the compression/decompression unit(s) during compression or decompression of the data for the current job, an attribute of the next job is identified, and it is determined whether or not the data for the next job will undergo compression or decompression based on the identified next-job attribute. Control means then controls the execution of processing of the next job by the compression/decompression unit(s) between pages of the current job in accordance with this determination.

Therefore, if the next job's attribute is such that processing of the current job would not be delayed, processing of the next job is executed between pages of the current job, while conversely, if the next job's attribute is such that processing of the current job would be delayed, processing of the next job is put on hold.

Because next-job processing is conducted only so long as there is no effect on current job processing based on the next-job attribute as described above, there is no reduction in productivity due to a delay in current-job processing. Furthermore, because the determination as to whether the next-job data will be compressed or decompressed is made based on the next-job attribute, appropriate processing control is executed and overall processing efficiency for the apparatus is improved.

An example of a next-job attribute would include whether the processing of the data for the next job is to take place on a page unit, band unit or block unit basis. Where the next-job data is to be processed in page units, the minimum processing time for the next-job data is long, and there is a risk that even minimal next-job processing cannot be carried out during the processing wait period between pages of the current job. Because the minimum processing time is shorter in the case of band unit or block unit processing, next-job processing can be conducted during the between-page processing wait periods for the current job.

Another example of a next-job attribute is the type of the next job.

Because whether the data for the next job is to be processed on a page unit, band unit or block unit basis is known beforehand based on the type of the next job, the determination as to whether next-job processing can be performed during the processing wait periods between-pages of the current job can be made by determining the type of the next job.

Another example of a next-job attribute is the input source of the next job.

Because it can be determined whether or not the next-job data is to undergo compression or decompression on a page unit basis can be made based on the next-job input source, it can be determined whether or not next-job processing can be performed during the between-page processing wait periods for the current job.

Other examples of a next-job attribute constitute whether the next-job data is binary data or multi-value data, or whether the next-job data is monochrome data or color data.

In the case of binary or monochrome data, because the amount of data per unit image is small, the minimum processing time is short, and the next job can be processed during the between-page processing wait periods for the current job. On the other hand, in the case of multi-value or color data, because the amount of data per unit image is large, the minimum processing time is long, and there is a risk that the next job cannot be processed during the between-page processing wait periods for the current job.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the construction of a data processing apparatus pertaining to an embodiment of the present invention;

FIG. 2 is a flow chart showing the sequence of a compression/decompression switching routine executed by the data processing apparatus of FIG. 1;

FIG. 3 is a drawing that describes a specific example of the next-page decompression wait period during processing of the current job and processing unit periods for a requested job; and

FIG. 4 is a flow chart that shows the sequence of the switching determination routine of step S105 in the flow chart shown in FIG. 2.

In the following description, like parts are designated by like reference numbers throughout the several drawings.

### DETAILED DESCRIPTION OF THE PREFERRED EMBODIMENTS

Embodiments of the present invention will be described below with reference to the attached drawings.

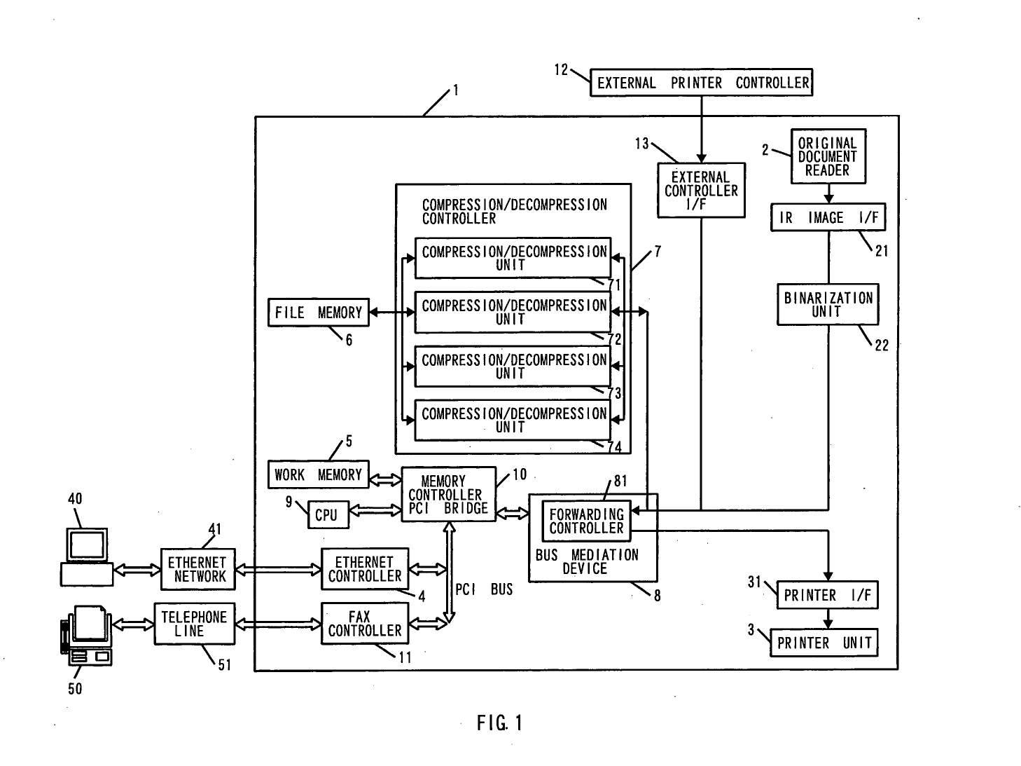

FIG. 1 is a block diagram of an MFP 1 constituting a data processing apparatus pertaining to an embodiment of the present invention.

This data processing apparatus includes multiple input means and multiple output means. In other words, it includes an original document reader 2 and an external controller interface (termed an ‘external controller I/F’ in the drawing) 13 that serve as input means, a printer unit 3 that serves as output means, an Ethernet controller 4 that serves both as input means and as output means, and a fax controller 11 that similarly serves both as input means and as output means.

The original document reader 2 includes a scanner that reads original documents, and the image data for the read original document is sent to a bus mediation device 8 via a read image interface (termed an ‘IR image I/F’ in the drawing) 21 and a binarization unit 22.

The external controller interface 13 receives print jobs from the external printer controller 12. The printer unit 3 prints the image data forwarded from the bus mediation device 8 onto paper or other medium. The binarization unit 22 converts the original document image data read by the original document reader 2 into binary data.

The Ethernet controller 4 sends and receives jobs over an Ethernet network 41. It receives over the Ethernet network 41 print jobs or Internet fax jobs sent by an external terminal device 40 such as a personal computer or an Internet fax machine, or sends to an external device 40 via the Ethernet network 41 image data for an original document read by the original document reader 2.

The fax controller 11 sends and receives fax jobs to and from external fax machines 50 over a telephone line 51. It receives a fax job sent by an external fax machine 50 via the telephone line 51, or sends to an external fax machine 50 over the telephone line 51 the image data for an original document read by the original document reader 2.

The MFP 1 also includes a work memory 5, a file memory 6, a compression/decompression controller 7, the bus mediation device 8, a CPU 9 and a memory controller-PCI bridge 10.

The work memory 5 processes data to be output or stores other data. Such data may include print data included in a print job sent from an external terminal device 40 and received by the Ethernet controller 4, data included in a fax job received by the fax controller 11, or image data read by the original document reader 2.

The compression/decompression controller 7 includes four compression/decompression units 71-74 that are connected in series in this embodiment. The compression/decompression controller 7 causes the compression/decompression units 71-74 to compress or decompress the output data described above by controlling these compression/decompression units 71-74. The compression/decompression units 71-74 can perform either compression or decompression.

The file memory 6 accumulates and stores the output data compressed by the compression/decompression units 71-74.

The bus mediation device 8 forwards the output data to the various components of the MFP via a forwarding controller 81.

The memory controller-PCI bridge 10 controls the state of data input and output to and from the work memory 5, and connects the CPU 9 bus and the PCI bus.

In addition to carrying out comprehensive control of the MFP 1, the CPU 9 has various other roles, including those of the memory controller-PCI bridge 10, the forwarding controller 81, and the compression/decompression controller 7. For example, the CPU 9 functions as processing wait period obtaining means that obtains the processing wait period between pages for a job that is being compressed or decompressed by the compression/decompression units 71-74. It also has the function of determining whether or not a request for compression or decompression of data for a next job has been issued while data for a current job is being compressed or decompressed. It also has the functions of (i) requesting the minimum processing time for the next-job data where a request for compression or decompression of next-job data has been issued, (ii) comparing this minimum processing time with the between-page processing wait period obtained with regard to the current job, (iii) identifying a particular attribute of the next job, and (iv) serving as means to permit or deny compression or decompression of the next job based on the comparison results or the job attribute.

The types of jobs that can be executed by the MFP 1 shown in FIG. 1 are copy jobs, scan jobs, internal print jobs, external controller print jobs, fax transmission jobs and fax receipt jobs. For each of these types of jobs, either data input or data output can occur.

The flow of data for each of these types of jobs is as described below.

[Data Input]

For copy jobs, scan jobs and fax transmission jobs, after the image data read by the original document reader 2 is sent to the binarization unit 22 via the read image interface 21 and binarized, it is forwarded to the work memory 5 as binary data, further forwarded to the compression/decompression units 71-74 for compression, and stored in the file memory 6. The forwarding to the compression/decompression units 71-74 and compression are carried out in page units.

For internal print jobs, after the print data sent from an external terminal device 40 via the Ethernet network 41 is received by the Ethernet controller 4, it undergoes RIP expansion in the work memory 5 and is converted into multi-value data, whereupon it is forwarded to the compression/decompression units 71-74 for compression and then stored in the file memory 6. Here, the tasks of forwarding to the compression/decompression units 71-74 and compression are carried out in band units (units obtained by dividing the data along the secondary scanning direction) or block units (units obtained by dividing the data along the primary and secondary scanning directions).

For fax receipt jobs, the image data sent from an external fax machine 50 via the telephone line 51 is received by the fax controller 11, forwarded to the work memory 5 as binary data, further forwarded to the compression/decompression units 71-74 for compression, and then stored in the file memory 6.

For external controller print jobs, after the print data sent from an external controller 12 is received by the external controller interface 13 as multi-value data and forwarded to the work memory 5, it is forwarded to the compression/decompression units 71-74 for compression and then stored in the file memory 6. Because the data undergoes RIP expansion in the external printer controller 12, the tasks of forwarding to the compression/decompression units 71-74 and compression are executed in page units.

[Data Output]

For copy jobs and fax receipt jobs, the compressed binary data read out from the work memory 5 is decompressed by the compression/decompression units 71-74, forwarded to the printer unit 3 via the work memory 5 and the printer interface 31, and finally printed.

For internal print jobs and external controller print jobs, the compressed multi-value data read out from the work memory 5 is decompressed by the compression/decompression units 71-74 and forwarded to the printer unit 3 via the work memory 5 and the printer interface 31, whereupon it is printed.

For scan jobs, the compressed binary data read out from the file memory 6 is decompressed by the compression/decompression units 71-74, forwarded to the Ethernet controller 4 via the work memory 5, and sent to an external terminal device 40 such as a personal computer via the Ethernet network 41.

For fax transmission jobs, the compressed binary data read out from the file memory 6 is decompressed by the compression/decompression units 71-74, forwarded to the fax controller 11 via the work memory 5, and sent to an external fax machine 50 via the telephone line 51.

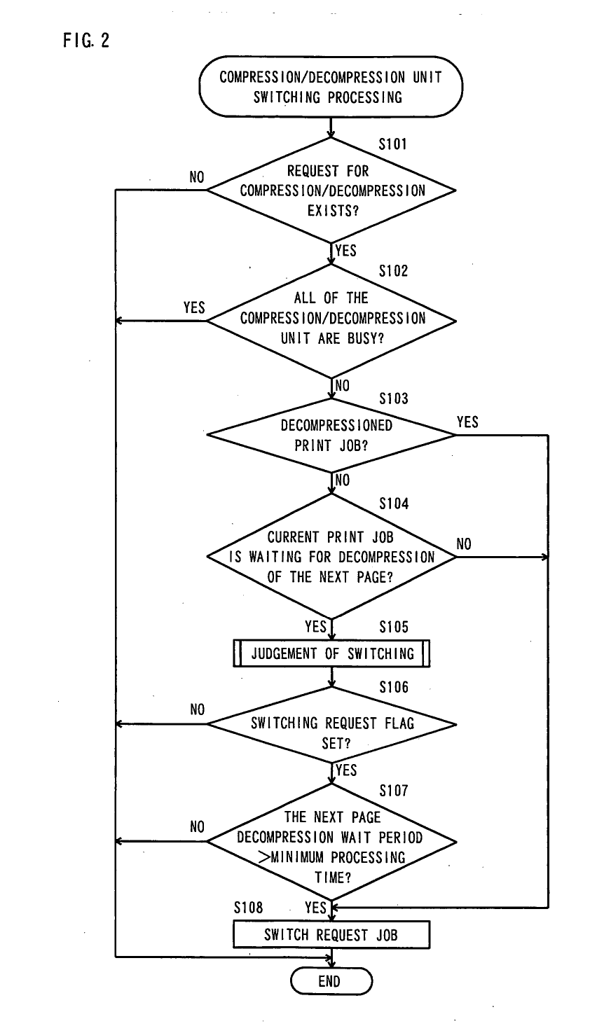

The compression/decompression unit switching routine performed by the CPU 9 of the MFP 1 shown in FIG. 1, when a request for compression of a next job by the compression/decompression units 71-74 is issued while compressed data for an existing print job that is stored in the file memory 6 is being decompressed by the compression/decompression units 71-74 is explained below with reference to the flow chart of FIG. 2.

This routine is called each time the compression or decompression process is begun for a given job, or each time processing by any of the compression/decompression units is completed.

First, in S101, the CPU 9 determines whether or not a request for compression or decompression has been issued. If such a request has not been issued (the determination in S101 is NO), the routine ends. If such a request has been issued (the determination in S101 is YES), the CPU 9 advances to S102 and it is determined whether all of the compression/decompression units 71-74 are being used.

If all of the compression/decompression units are being used (the determination in. S102 is YES), because switching is impossible, the CPU 9 ends the routine and processing is kept on hold until the current processing by the compression/decompression units 71-74 is completed.

If all of the compression/decompression units are not being used in S102 (the determination in S102 is NO), it is determined in S103 whether or not the requested job is a print job to be decompressed. If the job is a print job to be decompressed (the determination in S103 is YES), the CPU 9 advances to S108 and the decompression operation is begun by unconditionally permitting the use of the compression/decompression units 71-74

If the requested job is not a print job to be decompressed in S103 (the determination in S103 is NO), it is determined in S104 whether or not the current print job is waiting for decompression of the next page, and if the current print job is not waiting for decompression (the determination in S104 is NO), the CPU 9 advances to S108 and the processing described above is carried out.

If the current print job is waiting for decompression of the next page in S104 (the determination in S104 is YES), the switching determination subroutine is called in S105. While the details of this subroutine are described below, where it is determined that the compression/decompression units 71-74 may be used for the requested job based on the results of determination of various conditions in this subroutine, the switching request flag and the requested job processing unit time are set and the CPU 9 returns to the main routine.

It is determined in S106 whether or not this switching request flag is set. If it is not set (the determination in S106 is NO), that means that it has been determined that the compression/decompression units 71-74 cannot be used for the requested job, and therefore the routine ends. As a result, the compression processing for the next job is put on hold, and a decline in printing productivity caused by an interruption in the processing of the current print job is avoided.

If the switching request flag is set in S106 (the determination in S106 is YES), the CPU 9 advances to S107.

In S107, the next-page decompression wait period for the current job and the minimum processing time (also termed the ‘processing unit time’) for the requested job are compared based on the output from the above subroutine, and if the next-page decompression wait period is longer (the determination in S107 is YES), i.e., if it is confirmed that there will be no decline in printing productivity even if processing for the requested job is carried out, the routine for switching to the requested job is executed to the extent possible and is then ended in S108.

If the next-page decompression wait period is shorter (the determination in S107 is NO), because execution of the requested job would cause a decline in printing productivity, the routine ends without further processing and switching to the required job is prohibited.

Because the next-page decompression wait period is calculated from the print speed beforehand as the period of time between the completion of decompression for one page and the commencement of decompression for the next page, the CPU 9 continuously calculates and updates the difference between the current time and the next decompression commencement time.

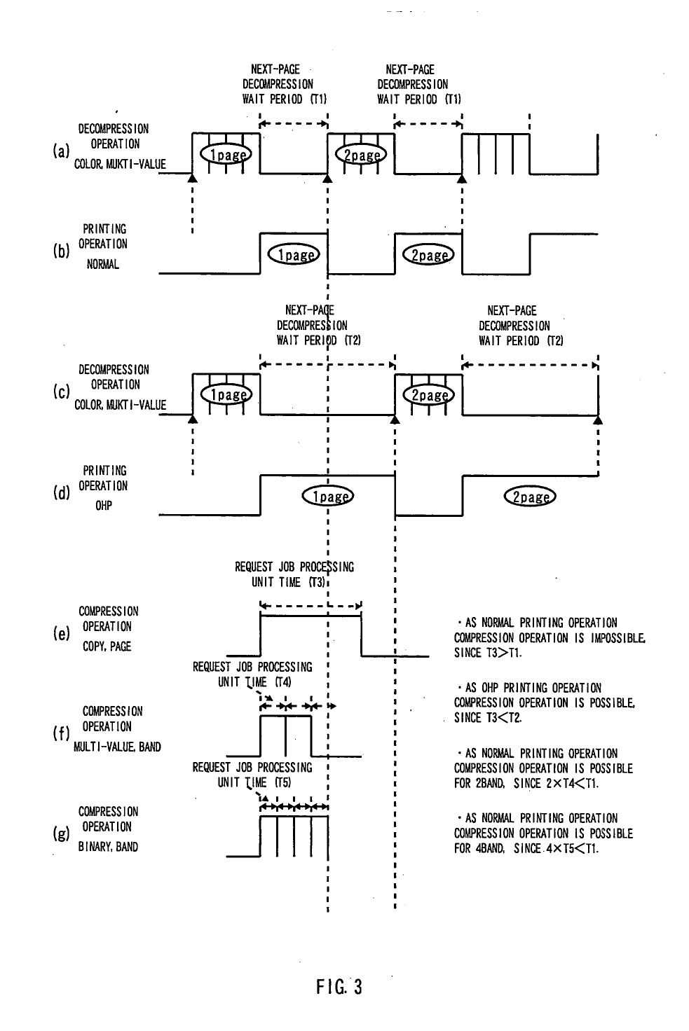

The next page decompression wait period and requested job processing unit time described above are shown using a specific example in FIG. 3.

The four waveforms in FIGS. 3(a)-3(d) show the relationship between the decompression operation and the printing operation for both normal printing and OHP printing, and the difference in the next-page decompression wait period is shown from a comparison between these graphs.

Specifically, since the fusing time required by the print engine of the printer unit 3 is longer for OHP printing that for normal paper printing and therefore the interval between print requests from the print engine is longer for OHP printing, while both OHP printing and normal printing require the same amount of time for decompression, the next-page decompression wait period T2 for OHP printing is longer than the equivalent period T1 for normal printing.

The three waveforms in FIGS. 3(e)-3(g) show the processing unit time (minimum processing time) required for compression regarding a copy job in the cases of (i) page unit printing, (ii) multi-value band unit printing, and (iii) binary band unit printing. Starting from the longest processing unit time, the page-unit processing unit time T3>the multi-value band-unit processing unit time T4>the binary band-unit processing unit time T5.

In the case of page-unit processing of a copy job, while a page unit cannot be compressed during the next-page decompression wait period Ti for normal printing, it can be compressed during the next-page decompression wait period T2 for OHP printing, as shown in FIG. 3(e).

In the case of multi-value band unit printing, processing of two bands can be performed during a decompression wait period for normal printing, as shown in FIG. 3(f). In addition, while not shown in the drawing, processing of the third band onward can be performed during a decompression wait period for OHP printing.

In the case of binary band unit printing, up to four bands can be processed during a decompression wait period for normal printing, as shown in FIG. 3(g).

As described above, by calculating and comparing the next-page decompression wait period for the current job and the processing unit time for the next job, the wait time for the hardware can be minimized and the productive efficiency of the overall system can be improved.

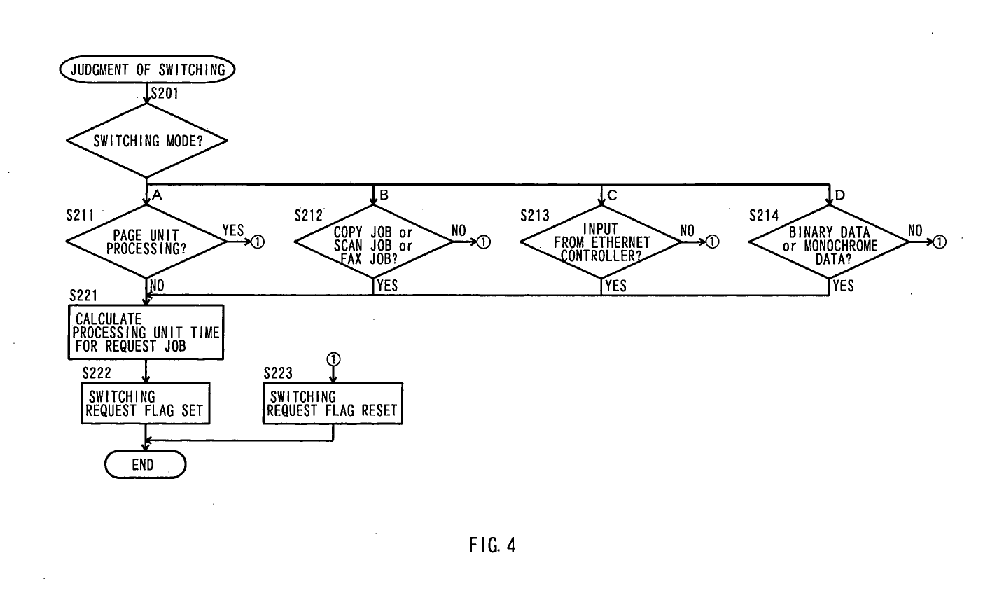

The sequence of the switching determination subroutine of S108 shown in FIG. 2 will now be explained with reference to the flow chart of FIG. 4. In this switching routine, whether switching is to be permitted is determined based on a job attribute.

First, a switching condition is selected in the switching mode determination process in S201. In this embodiment, a selected condition is registered in advance as an operating parameter for the MFP 1 from among multiple switching modes A-D.

The four types of switching modes A-D described below are present.

A. Page Switching (S211)

In this routine, because processing would require a significant amount of time if the units for compression/decompression are page units (the determination in S211 is YES), the CPU 9 advances to S223 to reset the switching request flag and prohibits switching to the requested job. If the units for compression/decompression are not page units (the determination in S221 is NO), since that means processing is executed in band units or block units, the processing time is relatively short. Therefore, after the CPU 9 advances to S221 and the processing unit time is calculated, the switching request flag is set in S222.

B. Switching Based on Job Type (S212)

In this routine, if the job is a copy job, scan job or fax job (the determination in S212 is YES), because the image attribute is handled as that of a binary image, and the image data size is therefore small, relatively little time is needed for compression or decompression. Therefore, the CPU 9 advances to S221 and S222 and the same processing as that described above is carried out. If the job is not a copy job, scan job or fax job (the determination in S212 is NO), because the image attribute is handled as that of a multi-value image, and the image data size is therefore large, processing is relatively time-consuming. Therefore, the CPU 9 advances to S223 and the same processing as that described above is carried out.

C. Switching Based on Data Input Source (S213)

In this routine, if the input source (data input source) is the Ethernet controller 4 (the determination in S213 is YES), because that means that the data forwarding is carried out in band units or block units, the processing unit time is relatively short. Therefore, the CPU 9 advances to S221 and S222 and the same processing as that described above is carried out.

If the input source (data input source) is not the Ethernet controller 4 (the determination in S213 is NO), because that means that the image input consists of page unit input from the original document reader 2 or an external controller 12, for example, processing is relatively time-consuming. Therefore, the CPU 9 advances to S223 and the same processing as that described above is carried out.

D. Data Attribute Switching (S214)

In this routine, switching is performed in accordance with the data attribute. Specifically, if the data is binary data or monochrome data, the data size is small, requiring a relatively short processing time. Therefore, the CPU 9 advances to S221 and S222 and the same processing as that described above is carried out. If the data is not binary data or monochrome data, the data size is large, requiring a relatively long processing time. Therefore, the CPU 9 advances to S223 and the same processing as that described above is carried out.

While an embodiment of the present invention was described above, the present invention is not limited to this embodiment. For example, a case in which a request for processing of a next job was issued during decompression of an existing job was described, but the present invention can also be applied when a next-job processing request is issued during compression of an existing job. Furthermore, the current job need not be a print job, and the next-job processing request may be a request for decompression.

In the flow chart of FIG. 2, both a routine in which next-job compression or decompression is permitted or denied based on a job attribute (S106), as well as a routine in which next-job compression or decompression is permitted or denied based on a comparison of the current-job between-page processing wait period and the next-job minimum processing time (S107) were executed, but it is acceptable if only one of these routines is executed. However, execution of both routines permits more precise control.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

1. A data processing apparatus comprising:
one or more compression/decompression units that compress the data for the input job and decompress the compressed data; and
a controller that, when a processing request is issued for processing of the data for a next job by said compression/decompression unit(s) during processing of the data for a current job by said compression/decompression unit(s), obtains the processing wait period between pages of said current job, determines whether or not the data for said next job will undergo compression or decompression based on a comparison between the minimum processing time for said next-job data and said processing wait period, and controls the execution of processing of said next job by said compression/decompression unit(s) between pages of said current job in accordance with this determination.

2. The data processing apparatus according to claim 1, wherein when said processing wait period is longer than said minimum processing time, said controller permits said compression/decompression unit(s) to process said next job between pages of said current job.

3. The data processing apparatus according to claim 1, wherein said job includes a copy job in which image data for an original document ready by an original document reader is printed out or a print job in which image data received from an external terminal is printed out.

4. A data processing apparatus comprising:
one or more compression/decompression unit(s) that compress the data for the input job and decompress the compressed data; and
a controller that, when a processing request is issued for processing of the data for a next job by said compression/decompression unit(s) during processing of the data for a current job by said compression/decompression unit(s), identifies an attribute of said next job, determines whether or not the data for said next job will undergo compression or decompression based on said identified next-job attribute, and controls the execution of processing of said next job by said compression/decompression unit(s) between pages of said current job in accordance with this determination.

5. The data processing apparatus according to claim 4, wherein said next-job attribute consists of whether the data processing for the next job is to take place on a page unit, band unit or block unit basis.

6. The data processing apparatus according to claim 4, wherein said next-job attribute consists of the type of the next job.

7. The data processing apparatus according to claim 4, wherein said next-job attribute consists of the input source for the next job.

8. The data processing apparatus according to claim 4, wherein said next-job attribute consists of whether the data is binary data or multi-value data.

9. The data processing apparatus according to claim 4, wherein said next-job attribute consists of whether the data is monochrome data or color data.

10. The data processing apparatus according to claim 4, wherein said job includes a copy job in which image data for an original document ready by an original document reader is printed out or a print job in which image data received from an external terminal is printed out.

11. A data processing apparatus comprising:
one or more compression/decompression unit(s) that compress the data for the input job and decompress the compressed data; and
a controller that, when a processing request is issued for processing of the data for a next job by said compression/decompression unit(s) during processing of the data for a current job by said compression/decompression unit(s), obtains the processing wait period between pages of said current job, identifies an attribute of said next job, and determines whether or not the data for said next job will undergo compression or decompression based on a comparison between the minimum processing time for said next-job data and said processing wait period, as well as on said identified next-job attribute, and controls the execution of processing of said next job by said compression/decompression unit(s) between pages of said current job in accordance with this determination.

12. The data processing apparatus according to claim 11, wherein said next-job attribute consists of whether the data for the next job is to take place on a page unit, band unit or block unit basis.

13. The data processing apparatus according to claim 11, wherein said next-job attribute consists of the type of the next job.

14. The data processing apparatus according to claim 11, wherein said next-job attribute consists of the input source for the next job.

15. The data processing apparatus according to claim 11, wherein said next-job attribute consists of whether the data is binary data or multi-value data.

16. The data processing apparatus according to claim 11, wherein said next-job attribute consists of whether the data is monochrome data or color data.

17. The data processing apparatus according to claim 11, wherein when said processing wait period is longer than said minimum processing time, said controller permits said compression/decompression unit(s) to process said next job between pages of said current job.

18. The data processing apparatus according to claim 11, wherein said controller compares said next-job data minimum processing time and said processing wait period after the next-job attribute is identified.

19. The data processing apparatus according to claim 11, wherein said job includes a copy job in which image data for an original document read by an original document reader is printed out or a print job in which image data received from an external terminal is printed out.
